(19) United States
(12) Patent Application Publication
(10) Pub. No.: US 2018/0158336 A1
(43) Pub. Date: Jun. 7, 2018

(54) METHOD AND DEVICE FOR OPERATING A VEHICLE

(71) Applicant: Robert Bosch GmbH, Stuttgart (DE)

(72) Inventor: Marlon Ramon Ewert, Untergruppenbach (DE)

(21) Appl. No.: 15/812,735

(22) Filed: Nov. 14, 2017

(30) Foreign Application Priority Data
Dec. 2, 2016 (DE) 10 2016 224 074.9

(51) Int. Cl. G08G 1/16; B60W 30/16; B60W 10/04; B60W 10/18; G08G 1/04; G08G 1/052

(52) U.S. Cl. CPC G08G 1/161; B60W 2750/306; B60W 10/04; B60W 10/18; G08G 1/165; G08G 1/167; G08G 1/168; G08G 1/04; G08G 1/052; B60W 2420/42; B60W 2420/52; B60W 2420/54; B60W 2550/12; B60W 2550/302; B60W 2550/308; B60W 2550/408; B60W 2550/306; B60W 2750/40; B60W 2750/302; B60W 2750/308; B60W 30/162

(57) ABSTRACT

A method for operating a vehicle, the method including a step of determining and a step of utilizing. In the step of determining, a distance between the vehicle and an infrastructure unit or another vehicle is determined by utilizing a propagation time of at least one signal between the vehicle and the infrastructure unit or the other vehicle. In the step of utilizing, the distance is utilized for activating a driver assistance function of the vehicle.

### CROSS REFERENCE

The present application claims the benefit under 35 U.S.C. § 119 of German Patent Application No. DE 102016224074.9 filed on Dec. 2, 2016, which is expressly incorporated herein by reference in its entirety.

### FIELD

The present invention is directed to a device, a method and a computer program for operating a vehicle.

### BACKGROUND INFORMATION

A vehicle may communicate with another vehicle and/or a surrounding infrastructure. In this case, information may be transmitted from and to the vehicle.

### SUMMARY

Wirelessly transmitted signals propagate from a sender at a known propagation speed. A signal requires a propagation time for a distance between the sender and a recipient. If the propagation time is known, the distance may be calculated. The propagation time therefore contains a piece of information in addition to a piece of transmitted signal information. The propagation time in this case is independent of the transmitted piece of information and may be uniformly utilized for various signals, including for determining the particular distance between the sender and the recipient.

An example method for operating a vehicle in accordance with the present invention includes:

determining a distance between the vehicle and an infrastructure unit or another vehicle by utilizing a propagation time of at least one signal between the vehicle and the infrastructure unit or the other vehicle; and

utilizing the distance for activating a driver assistance function of the vehicle.

An infrastructure unit may be, for example, a traffic light, a sign, or a reflector post. The vehicle may be a sender and/or a recipient. Likewise, the infrastructure unit may be a sender and/or a recipient. The communication may take place unidirectionally or reciprocally. A driver assistance function may be carried out by a driver assistance system of the vehicle.

A position of the vehicle may be determined by utilizing the distance and at least one further distance. The further distance may be determined by utilizing one further propagation time of at least one further signal between the vehicle and the infrastructure unit or the other vehicle. The position may be utilized for activating the driver assistance function. With the aid of two distances, the position may be established at two possible points. With the aid of three or more distances, the position may be unambiguously established.

A relative speed between the vehicle and the other vehicle may be determined by utilizing the distance and one further distance. The further distance may be determined by utilizing one further propagation time of one further signal between the vehicle and the other vehicle. The relative speed may be utilized for activating the driver assistance function. The distances may be determined at different points in time. The relative speed results from a difference between the distances and an elapsed period of time.

The distance may be determined when the infrastructure unit or the other vehicle is situated within a minimum distance around the vehicle. A minimum distance may be an upper limit for the utilized propagation times. As a result, long propagation times of signals may be ignored.

The signal may be transmitted with a time stamp. The propagation time may be determined by utilizing the time stamp. A time stamp may represent a point in time when the signal was sent. With the aid of a known point in time when the signal was received, the distance may also be determined in the case of a unidirectional communication.

The distance may be utilized for controlling the vehicle under adverse weather conditions. The propagation time is approximately independent of the weather conditions.

The distance may be utilized for avoiding a collision between the vehicle and the further vehicle. Maintenance of a safety distance may be checked by way of the known distance.

This method may be implemented, for example, in software or hardware or in a hybrid form of software and hardware, for example, in a control unit.

The approach presented here furthermore provides a device, which is designed for carrying out, controlling, or implementing the steps of a variant of a method presented here in corresponding units. The object of the present invention may also be rapidly and efficiently achieved with the aid of this embodiment variant of the present invention in the form of a device.

For this purpose, the device may include at least one processing unit for processing signals or data, at least one memory unit for storing signals or data, at least one interface to a sensor or an actuator for reading in sensor signals from the sensor or for outputting data or control signals to the actuator and/or at least one communication interface for reading in or outputting data which are embedded in a communication protocol. The processing unit may be, for example, a signal processor, a microcontroller, or the like, the memory unit being a flash memory, an EEPROM, or a magnetic memory unit. The communication interface may be designed for reading in or outputting data in a wireless and/or wire-bound manner, a communication interface—which may read in or output wire-bound data—reading in these data, for example, electrically or optically from a corresponding data transmission line or outputting these data into a corresponding data transmission line.

In the present case, a device may be understood to be an electrical device that processes sensor signals and, as a function thereof, outputs control and/or data signals. The device may include an interface, which may be in the form of hardware and/or software. In the case of an embodiment as hardware, the interfaces may be part of a so-called system ASIC, for example, which contains highly diverse functions of the device. It is also possible, however, that the interfaces are standalone, integrated circuits or are formed, at least in part, from discrete components. In the case of an embodiment as software, the interfaces may be software modules, which are present, for example, on a microcontroller in addition to other software modules.

In addition, a computer program product or a computer program including program code is advantageous, which may be stored on a machine-readable carrier or memory medium such as a semiconductor memory, a hard drive memory or an optical memory, and which may be used for carrying out, implementing, and/or controlling the steps of the method according to one of the above-described specific embodiments, in particular when the program product or program is carried out on a computer or a device.

Exemplary embodiments of the present invention are shown in the figures are described in greater detail below.

### BRIEF DESCRIPTION OF THE DRAWINGS

FIG. 1 shows a representation of a vehicle including a device according to one exemplary embodiment.

FIG. 2 shows a flow chart of a method for operating a vehicle according to one exemplary embodiment.

### DETAILED DESCRIPTION OF EXAMPLE EMBODIMENTS

In the description below of favorable exemplary embodiments of the present invention, identical or similar reference numerals are used for the similarly functioning elements represented in the different figures, a repeated description of these elements being dispensed with.

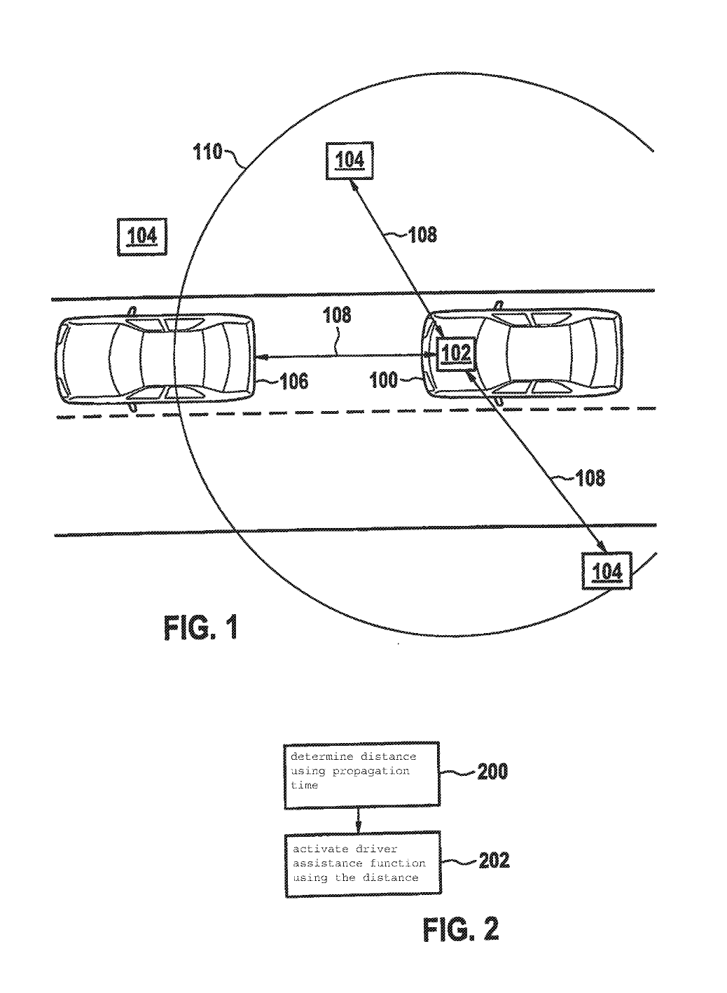

FIG. 1 shows a representation of a vehicle 100 including a device 102 according to one exemplary embodiment. Vehicle 100 is traveling on a road. Infrastructure units 104, such as, for example, traffic lights and reflector posts, are situated in the road surroundings. Another vehicle 106 is traveling on the road ahead of vehicle 100. Device 102 may communicate with infrastructure units 104 and other vehicles 106 via signals 108. By utilizing a propagation time of a signal 108 between one of the infrastructure units 104 or the other vehicle 106, device 102 calculates a distance between vehicle 100 and infrastructure unit 104 or the other vehicle 106 on the basis of a propagation speed of signals 108. A driver assistance system of vehicle 100 is controlled by utilizing the distance.

In one exemplary embodiment, device 102 communicates only with infrastructure units 104 and vehicles 106 within a surrounding area 110.

An autonomous vehicle 100 is a vehicle 100 which operates without a driver. In this case, vehicle 100 travels autonomously by way of automatically detecting, for example, the road course, other road users 106, or obstacles and calculating the corresponding control commands in vehicle 100 and forwarding the control commands to the actuators in vehicle 100, by which the driving course of vehicle 100 is correctly influenced. In the case of a fully autonomous vehicle 100, the driver is not involved in the driving process.

Driver assistance systems are electronic auxiliary units in motor vehicles 100 for assisting the driver in certain driving situations. Safety aspects, as well as the increase in driving comfort, are often of primary importance in this case. One further aspect is the improvement in fuel economy.

Driver assistance systems intervene semi-autonomously or autonomously into drive, control (for example gas, brake), or signaling units of the vehicle or warn the driver—by way of suitable human-machine interfaces—shortly before or during critical situations. Presently, most driver assistance systems are designed in such a way that the responsibility remains with the driver and, therefore, the driver is not rendered powerless.

Various types of surroundings sensor systems are utilized for driver assistance systems, inter alia, ultrasonic sensors in the case of a parking assistance system, radar sensors in the case of a lane-change assistant and an automatic distance warning system, LIDAR sensors in the case of a blind-spot monitoring system, an automatic distance warning system, a distance control system, a pre-crash and a pre-brake warning system, and cameras in the case of a lane departure warning system, a road-sign recognition system, a lane-change assistant, the blind-spot monitoring system, and an emergency braking system for pedestrian protection.

Car-to-car communication (Car2Car or C2C) is understood to mean the exchange of information and data between motor vehicles 100, 106. The objective of this data exchange is to signal critical and hazardous situations to the driver at an early point in time. In addition, vehicle-specific data may be exchanged between vehicles 100, 106 via this interface.

Relevant vehicles 100, 106 gather data, such as ABS interventions, steering angle, position, direction, and speed, and transmit these data by radio (WLAN, UMTS . . . ) to the other road users 100, 106. In this case, the “visual range” of the driver is to be extended with the aid of electronic means.

Car-to-infrastructure (C2I) is understood to mean the exchange of data between a vehicle 100 and the surrounding infrastructure 104, such as traffic light installations.

The aforementioned technologies are based on the interaction of sensors of different road users 100, 106 and utilize the newest methods of communication technology for exchanging this information.

It is highly likely that vehicles 100 or even autonomous or semi-autonomous vehicles 100 will exchange data with each other in the future with the aid of car-to-car communication systems.

Surroundings sensors installed in the vehicles nowadays have various disadvantages. Camera systems or LIDAR systems function, for example, only under good visibility conditions. Radar sensors are reflected on various surfaces and are therefore susceptible to interference. Satellite navigation systems are generally available, but, if insufficiently covered, may result in an impaired position determination in the vehicle. The described disadvantages make it difficult to implement fully autonomous vehicles in road traffic. The approach presented here comes into play at this point.

The present invention includes a method for determining distances between vehicles relative to infrastructure 104 on the basis of the signal propagation time of car-to-X communication signals 108, inter alia, in order to control vehicles 100.

In this case, it is assumed that car-to-X communication devices are integrated into vehicles 100, 106 and in relevant infrastructure 104, such as traffic light installations or signs. In this case, a data exchange therefore takes place between vehicles 100, 106 within a minimum distance M 110 and surrounding infrastructure 104, for example via the car-to-X communication. Minimum distance M 110 may be dependent on the vehicle speed, the signal quality of the car-to-X communication or on the weather conditions. Minimum distance M 110 depends, inter alia, on the signal quality of car-to-X communication signals 108.

Car-to-X communication signals 108 are provided with a time stamp. If a vehicle 100 sends, for example, a car-to-X communication signal 108 to surrounding infrastructure 104, the signal propagation time may be calculated within infrastructure 104 with the aid of the time stamp in message 108 after the receipt of message 108. In turn, the calculation of a distance between a vehicle 100 and corresponding infrastructure 104 takes place on the basis of the signal propagation time. The vehicle distance yields, over time, the position and relative speed of vehicle 100 relative to infrastructure 104. The reverse case is also conceivable, i.e., that car-to-X communication signals 108, including a time stamp, are sent from infrastructure 104 to vehicle 100. The calculation of the distance, the position, and the relative speed takes place in vehicle 100 itself in this case on the basis of the signal propagation times of car-to-X communication signals 108. At least two car-to-X communication signals 108, which are provided with a time stamp and which were exchanged between vehicle 100 and infrastructure 104, or vice versa, are necessary for the determination of the relative speeds of the vehicles.

The distances between vehicles and/or relative speeds and/or positions ascertained on the basis of the signal propagation times may be utilized, inter alia, for highly diverse applications.

In one exemplary embodiment, the gathered information is utilized for controlling vehicle 100 under adverse weather conditions when the surroundings sensors installed in vehicle 100 do not function properly. The control of vehicle 100 may take place in vehicle 100 itself with the aid of the calculated data or via control commands which were calculated in infrastructure 104 based on the data and which were sent to vehicle 100 within minimum distance 110.

In one exemplary embodiment, the gathered information is utilized for avoiding a collision between different vehicles 100, 106 by way of the distances between the vehicles being regulated in vehicles 100, 106 with the aid of the calculated data or via control commands which were calculated in infrastructure 104 based on the data and which were sent to vehicle 100 within minimum distance 110.

In one exemplary embodiment, infrastructure 104 may either actively emit radio signals 108 or carry out a pure forwarding/reflection of car-to-X communication signals 108 of vehicles 100, 106 together with an ID. In this way, the entire signal propagation time of a car-to-X communication signal 108 may be calculated in vehicle 100 after the reflection on reflector post 104 and assigned to an infrastructure 104 having an ID. Subsequently, the calculated signal propagation time is converted into a distance, whereby vehicle 100 knows the distance to infrastructure 104 having the appropriate ID.

FIG. 2 shows a flow chart of a method for operating a vehicle according to one exemplary embodiment. The method may be carried out on a device of the type represented in FIG. 1, for example. The method includes a step 200 of determining and a step 202 of utilizing. In step 200 of determining, a distance between the vehicle and an infrastructure unit or another vehicle is determined by utilizing a propagation time of at least one signal between the vehicle and the infrastructure unit or the other vehicle. In step 202 of utilizing, the distance is utilized for activating a driver assistance function of the vehicle.

In other words, a method is presented for determining distances between vehicles relative to the infrastructure on the basis of the signal propagation time of car-to-X communication signals, inter alia, in order to control the vehicles.

As a result, a considerable improvement in the navigation and trajectory planning of autonomous or semi-autonomous vehicles may be achieved primarily during adverse weather or at night. An additional redundancy results for surroundings sensors installed in the vehicle. An increase in the safety of road traffic may be achieved, since road courses are detected in an even better way by autonomous or semi-autonomous vehicles.

If an exemplary embodiment includes an “and/or” linkage between a first feature and a second feature, this is intended to be read that the exemplary embodiment according to one specific embodiment includes both the first feature and the second feature and, according to a further specific embodiment, includes either only the first feature or only the second feature.

What is claimed is:

1. A method for operating a vehicle, comprising:
determining a distance between the vehicle and one of an infrastructure unit or another vehicle by utilizing a propagation time of at least one signal between the vehicle and the one of the infrastructure unit or the other vehicle; and
utilizing the distance for activating a driver assistance function of the vehicle.

2. The method as recited in claim 1, wherein, in the determining step, a position of the vehicle is determined by utilizing the distance and at least one further distance, the further distance being determined by utilizing one further propagation time of at least one further signal between the vehicle and the one of the infrastructure unit or the other vehicle, and, in the utilizing step, the position is utilized for activating the driver assistance function.

3. The method as recited in claim 1, wherein, in the determining step, a relative speed between the vehicle and the other vehicle is determined by utilizing the distance and one further distance, the further distance being determined by utilizing one further propagation time of one further signal between the vehicle and the other vehicle and, in the utilizing step, the relative speed is utilized for activating the driver assistance function.

4. The method as recited in claim 1, wherein, in the determining step, the distance is determined when the one of the infrastructure unit or the other vehicle is situated within a minimum distance around the vehicle.

5. The method as recited in claim 1, wherein, in the determining step, the signal is transmitted with a time stamp, the propagation time being determined by utilizing the time stamp.

6. The method as recited in claim 1, wherein, in the utilizing step, the distance is utilized for controlling the vehicle under adverse weather conditions.

7. The method as recited in claim 1, wherein, in the utiliting step, the distance is utilized for avoiding a collision between the vehicle and the further vehicle.

8. A device for operating a vehicle, the device designed to:
determine a distance between the vehicle and one of an infrastructure unit or another vehicle by utilizing a propagation time of at least one signal between the vehicle and the one of the infrastructure unit or the other vehicle; and
utilize the distance for activating a driver assistance function of the vehicle.

9. A non-transitory machine-readable memory medium on which is stored a computer program for operating a vehicle, the computer program, when executed by a processor, causing the processor to perform:
determining a distance between the vehicle and one of an infrastructure unit or another vehicle by utilizing a propagation time of at least one signal between the vehicle and the one of the infrastructure unit or the other vehicle; and
utilizing the distance for activating a driver assistance function of the vehicle.
